(19) United States
(12) Patent Application Publication
(10) Pub. No.: US 2014/0170312 A1
(43) Pub. Date: Jun. 19, 2014

(54) METHOD OF MAKING RHENIUM COATING

(71) Applicant: Smith International, Inc., Houston, TX (US)

(72) Inventor: Qingyuan Liu, Orem, UT (US)

(73) Assignee: Smith International, Inc., Houston, TX (US)

(21) Appl. No.: 14/102,426

(22) Filed: Dec. 10, 2013

Related U.S. Application Data
(60) Provisional application No. 61/737,713, filed on Dec. 14, 2012.

(51) Int. Cl. B22F 1/02; C04B 35/628; C04B 35/645; B22F 3/14

(52) U.S. Cl. CPC B22F 1/025; B22F 3/14; C04B 35/62842; C04B 35/645
USPC 427/216; 419/10; 427/217; 264/118

(57) ABSTRACT

A method of forming rhenium coated metal particles, the method including directly mixing ammonium perrhenate with metal particles and converting the ammonium perrhenate to a rhenium coating on the metal particles, is disclosed. Methods of forming rhenium coated cubic boron nitride particles and rhenium coated diamond particles are also disclosed. Methods of manufacturing components of tools using the rhenium coated metal particles, the rhenium coated cubic boron nitride particles and/or rhenium coated diamond particles are also disclosed.

### CROSS-REFERENCE TO RELATED APPLICATION(S)

This application claims priority to and the benefit of U.S. Provisional Application Ser. No. 61/737,713, filed Dec. 14, 2012, entitled “METHOD OF MAKING RHENIUM COATING,” to Q. Liu, the disclosure of which is incorporated by reference herein in its entirety.

### BACKGROUND

Rhenium metal alloys are used industrially for high temperature thermo-resistance and thermal measurement applications. Such alloys can be made from metal powders including rhenium and another metal (e.g., tungsten). The rhenium metal alloys can be included in composite materials that also include an ultra-hard material, such as cubic boron nitride (“cBN”), carbides (e.g., tungsten carbide), and/or diamond (e.g., polycrystalline diamond). For example, the composite material can be made by high-pressure high-temperature (“HPHT”) sintering a mixture of tungsten-rhenium (“W—Re”) metal powder and an ultra-hard material. The composite material can be used to make precursor components (e.g., blanks) that can be made into parts for wear-resistance applications, such as parts for friction stir welding and processing.

The performance of parts made from W—Re metal powders depends upon characteristics of the W—Re metal powders, such as particle size, particle size distribution and morphology. Lab scale production of W—Re metal powders (e.g., plasma sputtering of Re on W surface) can produce powders that have varying consistency, such as drastically differing morphology and coating characteristics. Parts made from W—Re metal powders having undesirable characteristics may exhibit poor performance, such as lower strength, unsatisfactory wear and abrasion resistance, and fracturing or cracking. Additionally, lab-scale production of W—Re metal powders, such as plasma sputtering, use special equipment, consume high amounts of energy, and can be expensive. For example, commercially available W—Re metal powders can cost as much as $4,400 per kilogram.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

According to embodiments of the disclosed subject matter, rhenium coated metal particles can be formed by directly mixing ammonium perrhenate with metal particles and converting the ammonium perrhenate to a rhenium coating on the metal particles.

According to other embodiments of the disclosed subject matter, rhenium coated cubic boron nitride (cBN) particles can be formed by mixing ammonium perrhenate with cBN particles and converting the ammonium perrhenate to a rhenium coating on the cBN particles.

According to still other embodiments of the disclosed subject matter, rhenium coated diamond particles can be formed by mixing ammonium perrhenate with diamond particles and converting the ammonium perrhenate to a rhenium coating on the diamond particles.

### BRIEF DESCRIPTION OF THE DRAWINGS

The accompanying drawings, together with the specification, illustrate example embodiments of the disclosed subject matter, and, together with the description, serve to explain principles of the disclosed subject matter.

FIG. 1 is a flowchart showing an embodiment of a method of forming rhenium coated metal particles.

FIG. 2 is a flowchart showing an embodiment of a method of forming rhenium coated metal particles.

FIG. 3 is a flowchart showing an embodiment of a method of forming rhenium coated metal particles.

FIG. 4 is a flowchart showing an embodiment of a method of forming rhenium coated metal particles.

FIG. 5 is a flowchart showing an embodiment of a method of manufacturing a component of a tool.

FIG. 6 is a schematic perspective view of an embodiment of a friction stir welding tool joining two workpieces together.

FIG. 7 is a schematic cross-sectional view of the embodiment of the friction stir welding tool shown in FIG. 6 joining two workpieces together.

FIG. 8 is a schematic cross-sectional view of an embodiment of a cutting tool.

FIG. 9 is a flowchart showing an embodiment of a method of forming rhenium coated cubic boron nitride particles.

FIG. 10 is a flowchart showing an embodiment of a method of forming rhenium coated cubic boron nitride particles.

FIG. 11 is a flowchart showing an embodiment of a method of forming rhenium coated cubic boron nitride particles.

FIG. 12 is a flowchart showing an embodiment of a method of forming rhenium coated cubic boron nitride particles.

FIG. 13 is a flowchart showing an embodiment of a method of manufacturing a component of a tool.

FIG. 14 is a flowchart showing an embodiment of a method of forming rhenium coated diamond particles.

FIG. 15 is a flowchart showing an embodiment of a method of forming rhenium coated diamond particles.

FIG. 16 is a flowchart showing an embodiment of a method of forming rhenium coated diamond particles.

FIG. 17 is a flowchart showing an embodiment of a method of forming rhenium coated diamond particles.

FIG. 18 is a flowchart showing an embodiment of a method of manufacturing a component of a tool.

FIGS. 19-21 are graphs showing thermal analysis of rhenium samples formed by the reduction of ammonium perrhenate.

FIGS. 22-24 are SEM photographs of the rhenium metal samples formed by the reduction of ammonium perrhenate.

FIGS. 25-27 are graphs showing the results of EDAX scans of the rhenium metal samples formed by the reduction of ammonium perrhenate.

FIG. 28 is a graph showing one embodiment of a temperature program for the heating of ammonium perrhenate.

FIGS. 29-32 are SEM photographs of rhenium coated metal particles formed according to Example 1.

### DETAILED DESCRIPTION

In the following detailed description, only certain example embodiments of the disclosed subject matter are shown and described, by way of illustration. As those skilled in the art would recognize, the disclosed subject matter may be embodied in many different forms and should not be construed as being limited to the embodiments set forth herein. Also, in the context of the present application, when a first element is referred to as being “on” a second element, it can be directly on the second element or be indirectly on the second element with one or more intervening elements interposed therebetween. Like reference numerals designate like elements throughout the specification.

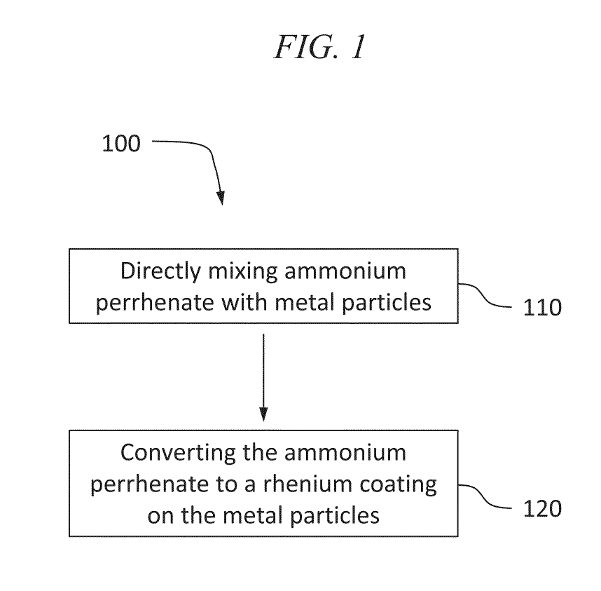

FIG. 1 is a flowchart showing an embodiment of a method (100) of forming rhenium coated metal particles. As shown in FIG. 1, the method (100) can include (block 110) directly mixing ammonium perrhenate (NH₄ReO₄) with metal particles (e.g., metal particles other than rhenium metal particles) and (block 120) converting the ammonium perrhenate to a rhenium coating on the metal particles. As used herein, the term “directly mixing ammonium perrhenate with metal particles” refers to physically mixing the ammonium perrhenate (or a mixture including the ammonium perrhenate and one or more other compounds) and the metal particles (e.g., tungsten metal particles, or a mixture including the metal particles and one or more other compounds). As such, mixing an ammonium perrhenate precursor and metal particles, and then converting the ammonium perrhenate precursor to ammonium perrhenate is not equivalent to directly mixing ammonium perrhenate with metal particles as described herein. Additionally, mixing ammonium perrhenate with a precursor of metal particles (e.g., metal oxide particles) and converting the precursor to metal particles is not equivalent to directly mixing ammonium perrhenate with metal particles as described herein. As used herein, the terms “directly mixing with cubic boron nitride particles” and “directly mixing with diamond particles” have meanings that are substantially similar to the above-described meaning of the term “directly mixing ammonium perrhenate with metal particles.”

In some embodiments, the rhenium coated metal particles are formed as a metal-rhenium powder. For example, the metal particles can be tungsten metal particles, and the rhenium coated tungsten particles can be formed as a tungsten-rhenium powder. According to embodiments of the method, the metal particles (e.g., tungsten metal particles) are first directly mixed with the ammonium perrhenate in a pre-set or pre-determined ratio based on the ratio of tungsten and rhenium in the resulting metal-rhenium powder. For example, the ammonium perrhenate can be directly mixed with the metal particles at a ratio such that the atomic percentage of rhenium in the resulting metal-rhenium powder is less than 30 at. %, such as an amount in a range of about 25 at. % to about 27 at. %, but the present application is not limited thereto. In some embodiments, the ammonium perrhenate is directly mixed with the metal particles at a ratio such that the atomic percentage of the metal (e.g., the metal other than rhenium, such as tungsten) in the metal-rhenium powder is more than 70 at. %, such as an amount in a range of about 73 at. % to about 75 at. %, but the present application is not limited thereto.

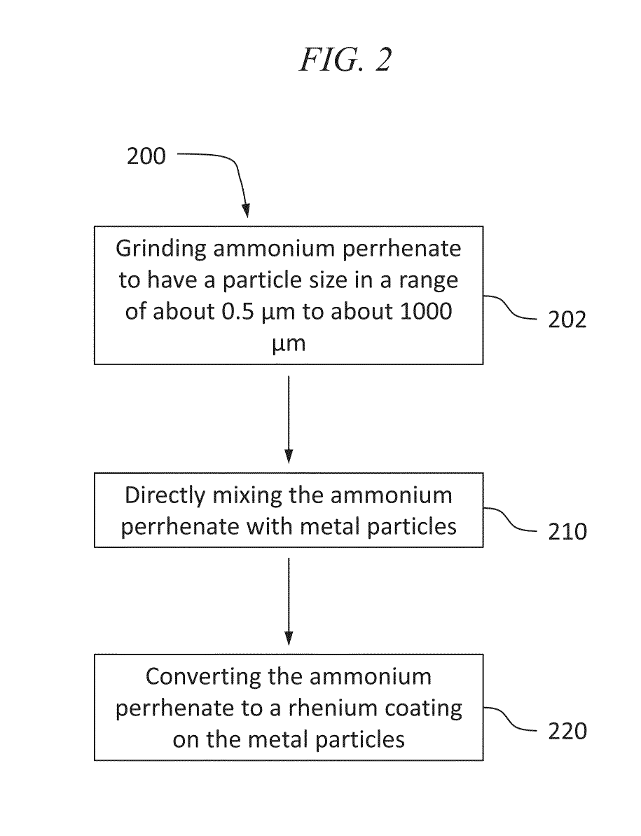

Prior to the direct mixing, the ammonium perrhenate can be ground into a fine powder. For example, the ammonium perrhenate can be ground using a mill (e.g., a ball mill) and/or a mortar and pestle (e.g., an alumina mortar and pestle). Grinding the ammonium perrhenate prior to the direct mixing may improve the uniformity of the mixture of ammonium perrhenate and the metal particles. For example, commercially available ammonium perrhenate may be sold as a coarse powder, and grinding the ammonium perrhenate may improve the uniformity of a powder made from the commercially available ammonium perrhenate. In some embodiments, the ammonium perrhenate has an average particle size in a range of about 0.5 μm to about 1000 μm prior to being directly mixed with the metal particles. For example, as shown in FIG. 2, an embodiment of the method (200) includes (block 202) grinding ammonium perrhenate to have a particle size in a range of about 0.5 μm to about 1000 μm, (block 210) directly mixing ammonium perrhenate (NH₄ReO₄) with metal particles (e.g., metal particles other than rhenium metal particles) and (block 220) converting the ammonium perrhenate to a rhenium coating on the metal particles. By using ammonium perrhenate having a smaller particle size, the uniformity and consistency of the coating may be improved. As a result, the amount of ammonium perrhenate used may be reduced and still achieve desired material properties, which can produce cost savings, as rhenium is often the most expensive component of metal-rhenium powders (e.g., tungsten-rhenium powders) and composite materials made from metal-rhenium powders. For example, when the ammonium perrhenate has a particle size in a range of about 0.5 μm to about 1000 μm, the uniformity and consistency of a coating prepared from the ammonium perrhenate is improved as compared to coatings prepared from ammonium perrhenate not having a particle size within the foregoing range. When a metal-rhenium powder (or ultra-hard material-rhenium powder) is prepared from ammonium perrhenate having a particle size within the foregoing range, less rhenium can be used while still achieving desired material properties, thereby reducing the cost of the powder and the cost of composite materials made from the powder.

The uniformity of the mixture of ammonium perrhenate and the metal particles may also be improved by using metal particles having a small particle size. For example, the metal particles can have an average particle size less than 10 μm. By using metal particles having a smaller particle size, the amount of ammonium perrhenate used may be reduced to achieve desired material properties, which can produce cost savings, as rhenium is often the most expensive component of metal-rhenium powders (e.g., tungsten-rhenium powders) and composite materials made from metal-rhenium powders.

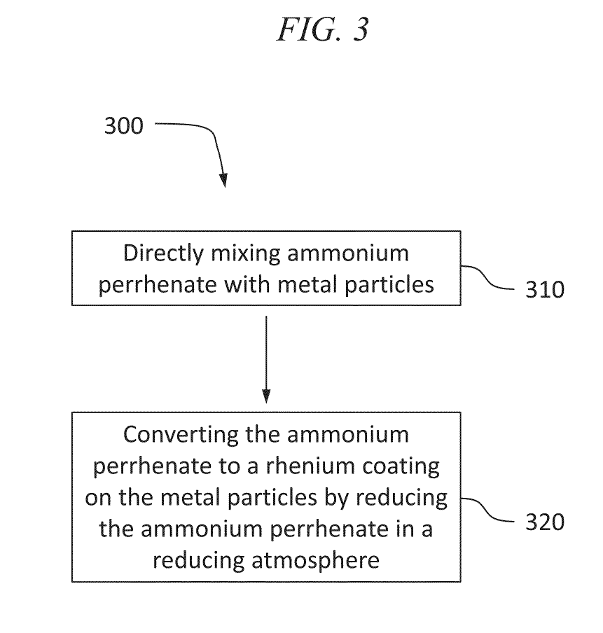

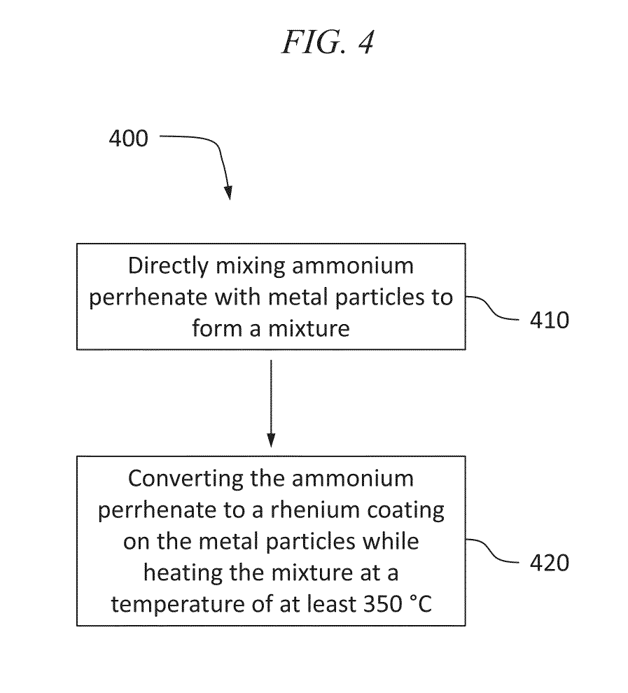

After the ammonium perrhenate is directly mixed with the metal particles, the ammonium perrhenate is converted to a rhenium coating on the metal particles. For example, the conversion of ammonium perrhenate can include reducing the ammonium perrhenate in a reducing atmosphere (e.g., a hydrogen atmosphere). As shown in FIG. 3, an embodiment of the method (300) includes (block 310) directly mixing ammonium perrhenate (NH₄ReO₄) with metal particles (e.g., metal particles other than rhenium metal particles) and (block 320) converting the ammonium perrhenate to a rhenium coating on the metal particles in a reducing atmosphere. As shown in FIG. 4, an embodiment of the method (400) includes (block 410) directly mixing the ammonium perrhenate with the metal particles to form a mixture and (block 420) converting the ammonium perrhenate to a rhenium coating on the metal particles while heating the mixture at a temperature of at least 350° C. (e.g., heating the mixture in a furnace heated to 350° C.), for example a temperature in a range of about 350° C. to about 750° C., such as a temperature less than about 750° C. For example, the mixture can be heated under a reducing atmosphere (e.g., a hydrogen atmosphere) in a furnace heated to 350° C.

In one example embodiment, the reduction reaction of ammonium perrhenate takes place at a temperature of at least about 350° C. when the furnace is heated at a rate of 5° C./min. Heating the furnace to higher temperatures may ensure completion of the reduction reaction, help accelerate the reduction reaction, and, to some degree facilitate annealing and/or recrystallizing of the product powder. While higher temperatures can be used, exceeding a temperature of about 1100° C. may result in the particles being fused together, which makes it more difficult for the particles to be mixed with an ultra-hard material (e.g., cBN, carbides, diamond, and the like).

Reducing the ammonium perrhenate produces rhenium metal that is uniformly mixed with the metal particles in the form of a coating. For example, reducing the ammonium perrhenate can produce a coating of rhenium metal on each of the metal particles. The formation of the coating can create a new interface between the rhenium coating and the metal on which the rhenium is coated. The creation of the interface can increase the reactivity between the rhenium coating and the metal particles, which can enhance the reaction (e.g., alloying) between these metals in subsequent processing (e.g., HPHT sintering) and improve the performance of components made from the rhenium coated metal particles. In some embodiments, a portion of the ammonium perrhenate is converted into a coating on the metal particles. For example, some of the ammonium perrhenate may be reduced to form particles (e.g., separate particles) of rhenium that are not coated on the metal particles. Additionally, some amount of residual, unconverted ammonium perrhenate may remain in the mixture.

The reduction reaction of the ammonium perrhenate can be illustrated by the following Reaction 1:

2NH₄ReO₄+7H₂→2Re+2NH₃+8H₂O (1)

The products of the reduction reaction include rhenium metal, ammonia gas, and water vapor. According to embodiments of the methods described herein, the rhenium metal is coated on the surface of the metal particles (e.g., the tungsten metal particles). The high temperature reaction can also create a pre-alloyed interface between the rhenium and the metal particles.

It is believed that the thermal decomposition of ammonium perrhenate is dependent upon the temperature and the heating rate of the furnace. At 200° C., the slow thermal decomposition begins with the formation of an amorphous oxide. In the range of 277-390° C., a reaction takes place according to the following Reaction 2:

2NH₄ReO₄→2ReO₂+2H₂O+N₂ (2)

At higher temperatures, the thermal decomposition may be accompanied by a parallel side reaction according to the following Reaction 3:

2NH₄ReO₄→Re₂O₇+2NH₃+H₂O (3)

When the conversion of the ammonium perrhenate is carried out in a reducing atmosphere (e.g., in the presence of hydrogen), the oxides from Reactions 2 and 3 (e.g., ReO₂ and Re₂O₇) will be reduced to rhenium metal. Accordingly, the main reactions for the thermal decomposition of ammonium perrhenate are believed to be Reaction 1 and the reduction of oxides resulting from Reactions 2 and 3.

In addition, some other intermediate oxides may form at temperatures above 275° C. For example, ReO₃ may be produced as a result of an auxiliary side reaction. It may be desirable to avoid the formation of ReO₃, since ReO₃ can be volatilized and reduced in hydrogen and may result in contamination of the heat source (e.g., the furnace). The formation of ReO₃ can be avoided by carefully heating the heat source (e.g., the furnace), for example, by carefully designing a program that controls the heating of the heat source, to avoid temperature profiles that result in the formation of ReO₃.

According to embodiments of the disclosed subject matter, the furnace cycle can start with a slow ramping of temperature to 300° C. in an inert atmosphere, such as argon (“Ar”). It is expected that under such conditions, the majority of the thermal decomposition product of ammonium perrhenate will be ReO₂ according to Reaction 2. In some embodiments, the furnace is subsequently flushed with H₂ gas at 300° C., and the ReO₂ is expected to be reduced to Re metal according to the following Reaction 4:

ReO₂+2H₂→Re+2H₂O (4)

While initially ramping the temperature under an inert atmosphere may be desirable to prevent contamination of the furnace, such ramping may be unnecessary. Additionally, the use of an inert atmosphere may not be necessary.

As described herein, embodiments of the method of forming rhenium coated metal particles provide a reduction in cost and an improvement in the consistency of the resulting product, as compared to other methods of forming rhenium coated metal particles. For example, commercially available tungsten-rhenium powder can cost as much as $4,400 per kilogram, while the raw materials (e.g., ammonium perrhenate and tungsten metal powder) used for embodiments of the methods described herein are commercially available at a cost of about $1,200 per kilogram of tungsten-rhenium powder produced. Tungsten metal powders are available from Global Tungsten & Powders Corp. (Towanda, Pa.) and ammonium perrhenate is available from ZhuZhou KETE Industries Co., Ltd. (Dongjiaduan High-Tech Park, ZhuZhou, China). Additionally, the tungsten-rhenium powders produced according to embodiments of the present methods are believed to produce more consistent particle size, particle size distribution and/or morphology than tungsten-rhenium powders produced according to lab-scale procedures (e.g., plasma sputtering rhenium on the tungsten surface).

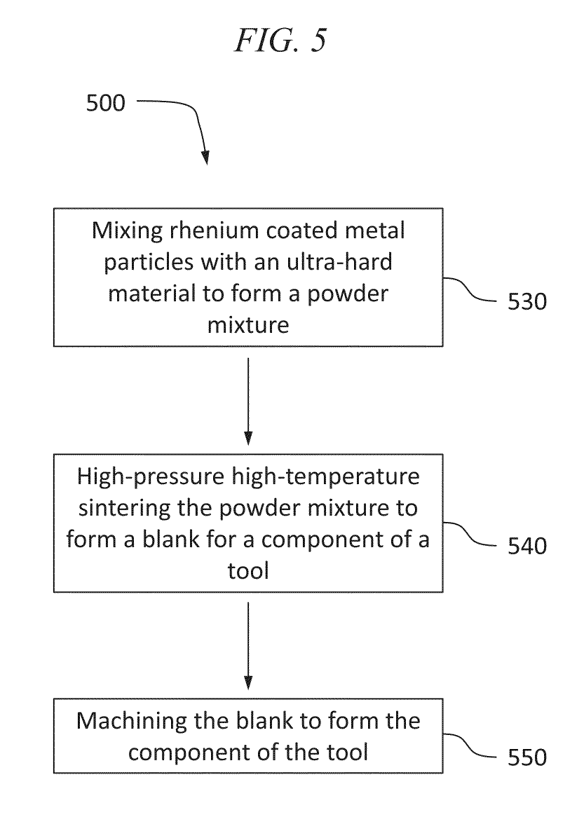

Embodiments of the above-described rhenium coated metal particles can be used in the manufacture of various tools, such as friction stir welding tools, but the present application is not limited thereto. FIG. 5 is a flowchart illustrating an embodiment of a method (500) of manufacturing a component of a tool. As shown in FIG. 5, the method (500) can include (block 530) mixing rhenium coated metal particles with an ultra-hard material (e.g., cubic boron nitride, carbides, diamond, and the like) to form a powder mixture. The rhenium coated metal particles can be formed according to the above-described embodiments. The method (500) further includes (block 540) high-pressure high-temperature sintering the powder mixture to form a blank for a component of a tool. The method (500) also includes (block 550) machining the blank to form the component of the tool. For example, the methods described herein can be used to make W—Re/cBN composite materials having 60, 70 or 80 volume percent of cBN ultra-hard particles, which can be used to make components of a friction stir welding tool. The machining can include grinding or lapping, but the present application is not limited thereto. Any suitable tool (e.g., a friction stir welding tool) can be made according to embodiments of the subject matter disclosed herein.

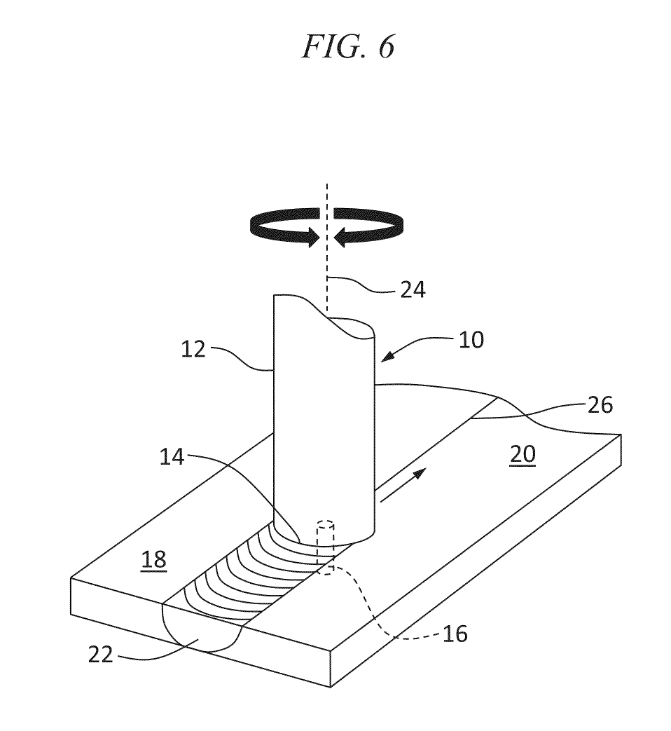

An example of one embodiment of a friction stir welding tool 10 is shown in FIG. 6, but the present application is not limited thereto. As shown in FIG. 6, the friction stir welding tool 10 includes a spindle 12 having a shoulder 14, and a pin 16, which penetrates the materials to be joined and does the “stirring.” The shoulder 14 can also “stir” the materials to be joined. The friction stir welding tool rotates in one direction about an axis 24, but, as shown in FIG. 6, the friction stir welding tool can be configured to rotate in either direction. By rotating about the axis 24, the friction stir welding tool 10 mechanically joins two workpieces 18 and 20 by plastic deforming and mixing the materials being joined at sub-melting temperatures. The workpieces 18 and 20 (e.g., metallic materials) have respective edges aligned at interface 26.

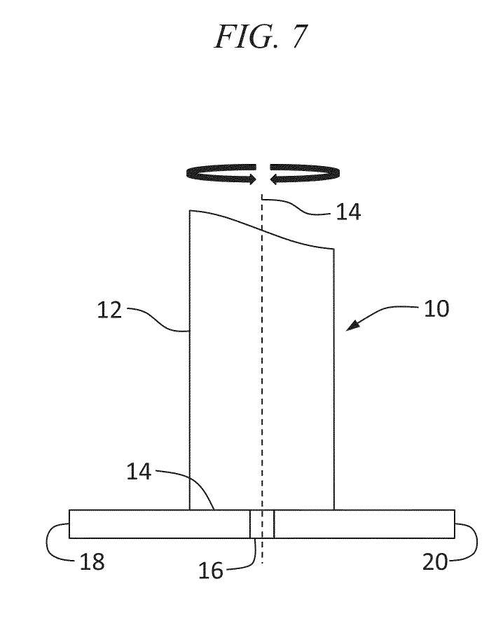

As shown in FIG. 6 and the cross-sectional view shown in FIG. 7, the pin 16 can penetrate into the two workpieces 18 and 20 (e.g., metal pieces) with the shoulder 14 contacting surfaces of the workpieces 18 and 20. The friction stir welding tool 10 is driven to rotate by the spindle 12, thereby “stirring” the materials to be joined. Rotating the friction stir welding tool 10 generates heat as a result of friction between the pin 16 and the workpieces 18 and 20, and between the shoulder 14 and the workpieces 18 and 20. A force directed toward the workpieces 18 and 20 (e.g., a downward force) can be applied to the friction stir welding tool 10 to maintain pressure and to facilitate the production of heat through friction. The heat generated by the friction stir welding tool 10 causes a portion of each of the workpieces 18 and 20 to plasticize. As the friction stir welding tool 10 travels along the interface 26, a weld 22 is formed between the workpieces 18 and 20.

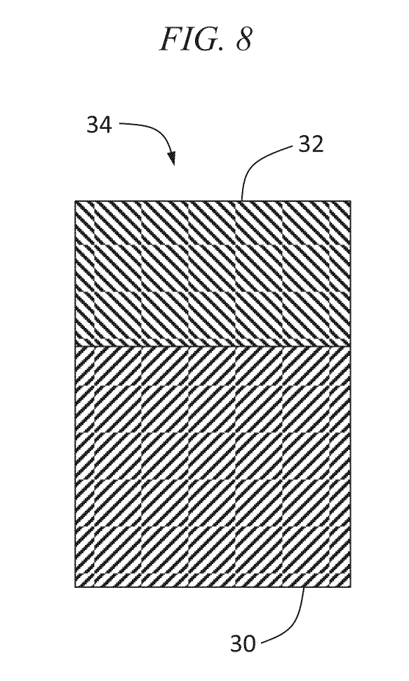

Tools other than friction stir welding tools can be formed according to embodiments of the present disclosure. For example, embodiments of the present disclosure can be used to form a cutting tool as shown in FIG. 8. For example, a composite material can be formed by forming the above-described rhenium coated metal particles, mixing the rhenium coated metal particles with an ultra-hard material to form a mixture, and high-pressure high-temperature sintering the mixture to form the composite material. As shown in FIG. 8, the composite material can be on a substrate 30 (e.g., tungsten carbide) to form a cutting layer 32 of a cutting element 34. For example, the composite material can be bonded (e.g., welded or brazed) to the substrate after the composite material has been sintered. In another embodiment, prior to sintering, the mixture and the substrate can be placed in a can together and sintered, thereby forming the composite material bonded to the substrate.

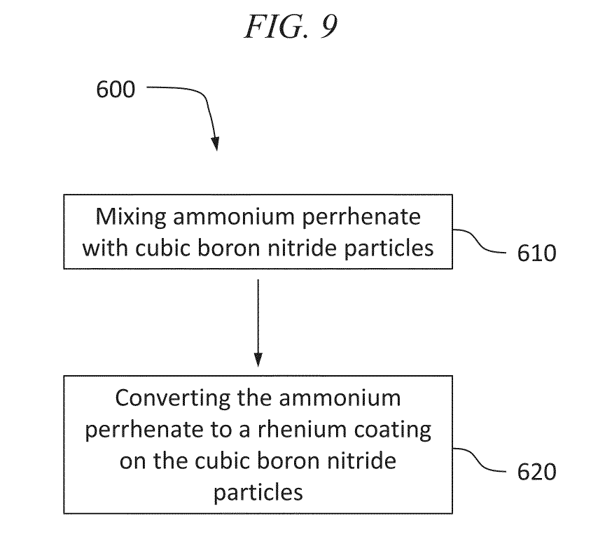

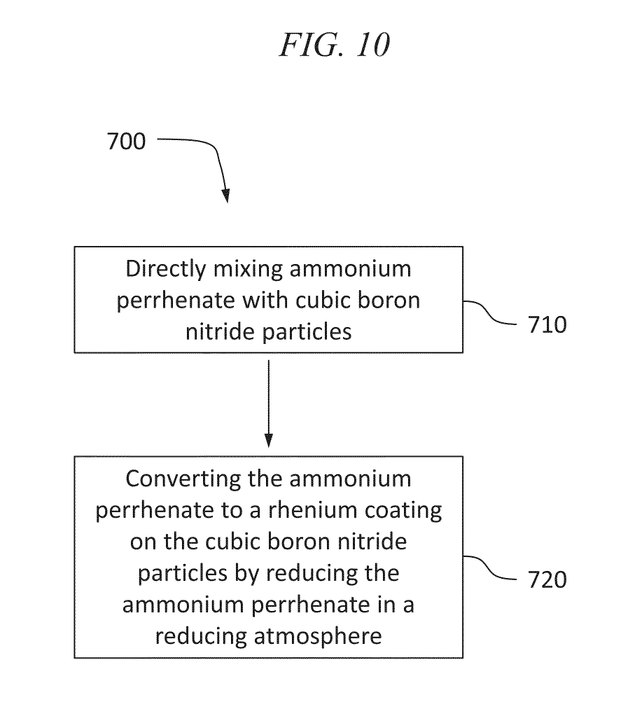

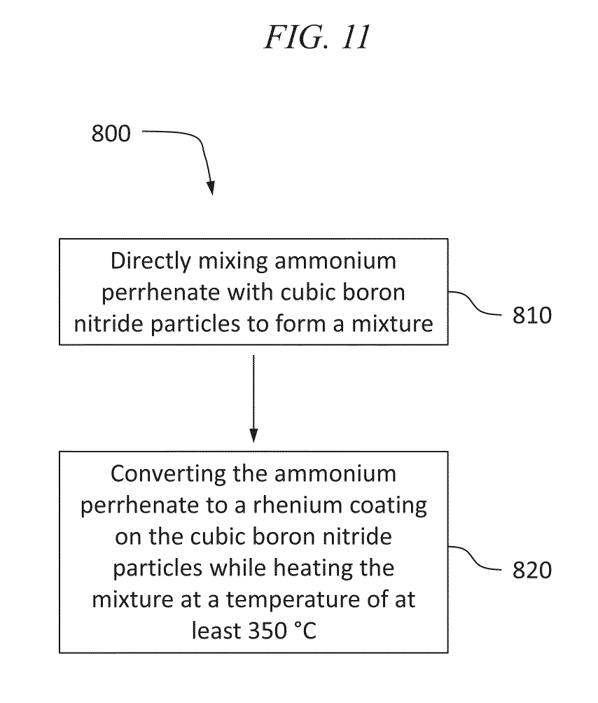

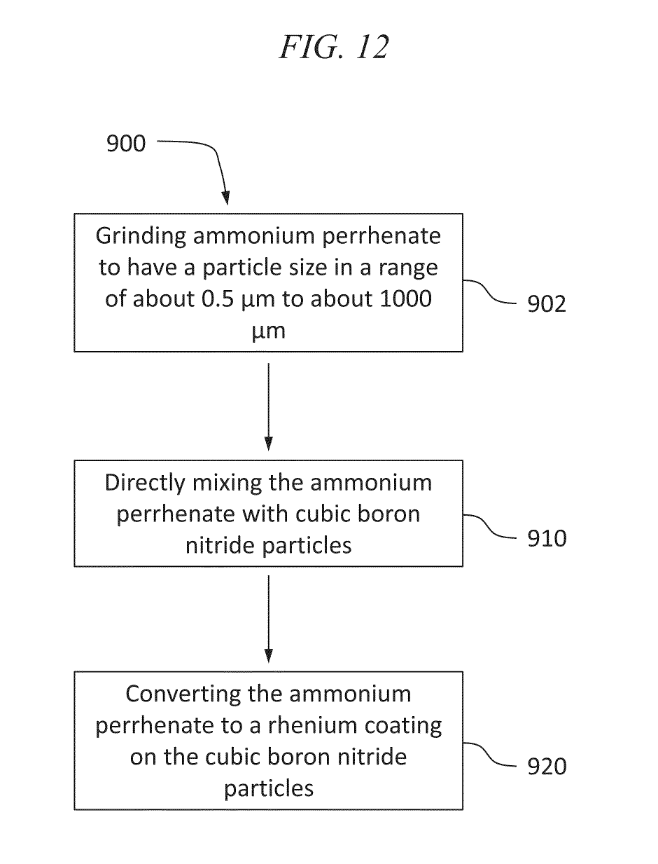

Embodiments of the subject matter disclosed herein are also directed to methods of forming rhenium coated cubic boron nitride particles. For example, FIG. 9 is a flowchart illustrating a method (600) including (block 610) mixing ammonium perrhenate with cubic boron nitride particles and (block 620) converting the ammonium perrhenate to a rhenium coating on the cubic boron nitride particles. As described above, the conversion of ammonium perrhenate can include reducing the ammonium perrhenate in a reducing atmosphere (e.g., a hydrogen atmosphere). As shown in FIG. 10, an embodiment of the method (700) includes (block 710) directly mixing ammonium perrhenate (NH₄ReO₄) with cubic boron nitride particles and (block 720) converting the ammonium perrhenate to a rhenium coating on the cubic boron nitride particles in a reducing atmosphere. As shown in FIG. 11, an embodiment of the method (800) includes (block 810) directly mixing the ammonium perrhenate with the cubic boron nitride particles to form a mixture and (block 820) converting the ammonium perrhenate to a rhenium coating while heating the mixture at a temperature of at least 350° C. (e.g., heating in a furnace heated to a temperature of at least 350° C.), for example a temperature in a range of about 350° C. to about 750° C., such as a temperature less than about 750° C. As shown in FIG. 12, an embodiment of the method (900) can also include (block 902) grinding the ammonium perrhenate to have a particle size in a range of about 0.5 μm to about 1000 μm, (block 910) directly mixing the ammonium perrhenate with the cubic boron nitride particles, and (block 920) converting the ammonium perrhenate to a rhenium coating on the cubic boron nitride particles. The remaining aspects of the method are substantially the same as those described above with respect to forming rhenium coated metal particles and, therefore, further description thereof will be omitted.

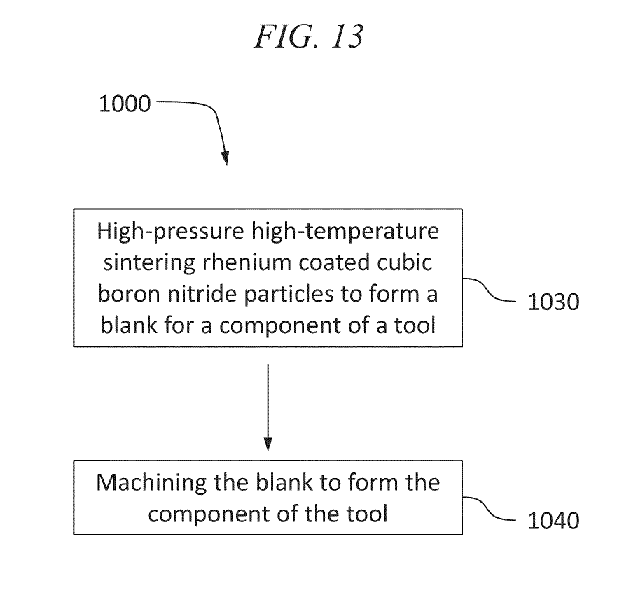

Embodiments of the above-described rhenium coated cubic boron nitride particles can be used in the manufacture of various tools, such as friction stir welding tools, but the present application is not limited thereto. For example, FIG. 13 is a flowchart illustrating an embodiment of a method (1000) of manufacturing a component of a tool. As shown in FIG. 13, the method (1000) can include (block 1030) high-pressure high-temperature sintering rhenium coated cubic boron nitride particles to form a blank for a component of a tool. The rhenium coated cubic boron nitride particles can be formed according to the above-described embodiments. The method (1000) can further include (block 1040) machining the blank to form the component of the tool. The method can also further include mixing the rhenium coated cubic boron nitride particles with tungsten metal particles before the high-pressure high-temperature sintering. In some embodiments, the method includes mixing the rhenium coated cubic boron nitride particles with a mixture of tungsten metal particles and rhenium metal particles, and/or the above-described rhenium coated metal particles, before the high-pressure high-temperature sintering. The remaining aspects of the method are substantially the same as those described above with respect to manufacturing a tool using rhenium coated metal particles and, therefore, further description thereof will be omitted. Any suitable tool (e.g., a friction stir welding tool) can be made according to embodiments of the subject matter disclosed herein.

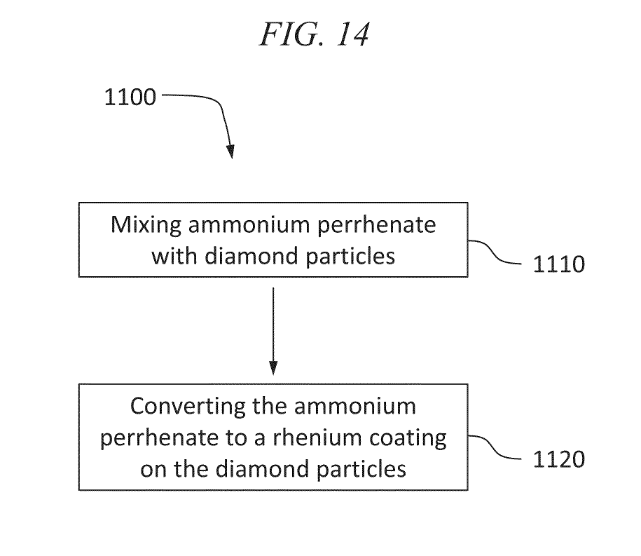

Embodiments of the subject matter disclosed herein are also directed to methods of forming rhenium coated diamond particles. For example, FIG. 14 is a flowchart illustrating a method (1100) including (block 1110) mixing ammonium perrhenate with diamond particles and (block 1120) converting the ammonium perrhenate to a rhenium coating on the diamond particles.

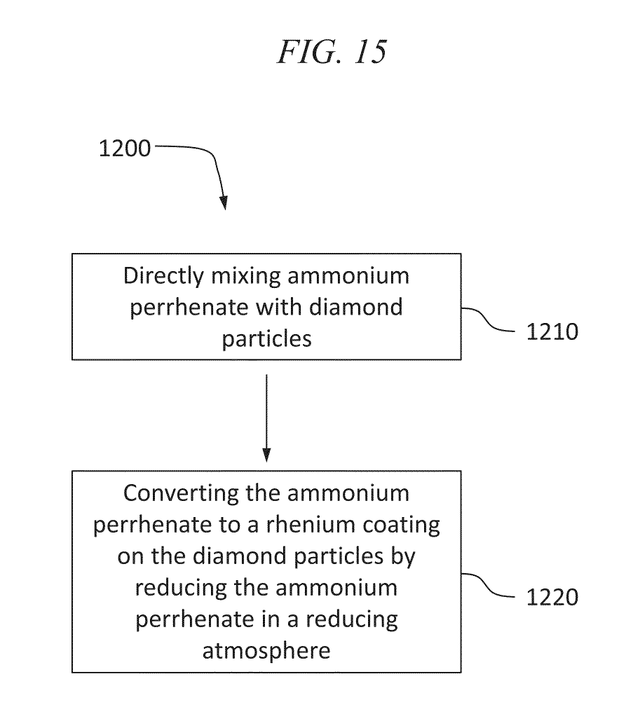

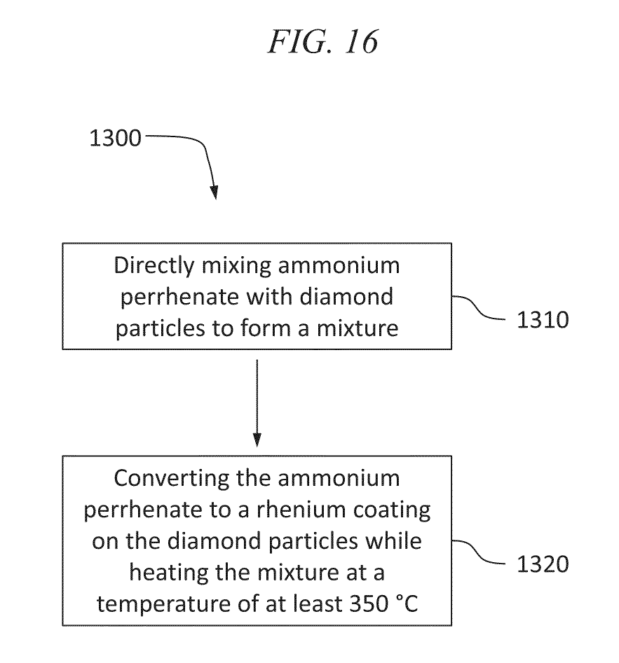

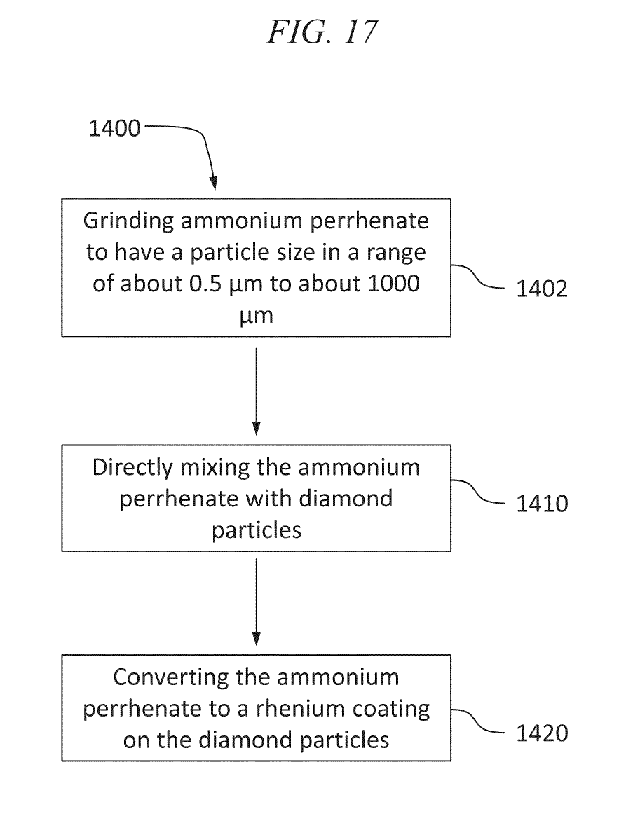

As described above, the converting the ammonium perrhenate can include reducing the ammonium perrhenate in a reducing atmosphere (e.g., a hydrogen atmosphere). As shown in FIG. 15, an embodiment of the method (1200) includes (block 1210) directly mixing ammonium perrhenate (NH₄ReO₄) with diamond particles and (block 1220) converting the ammonium perrhenate to a rhenium coating on the diamond particles in a reducing atmosphere. As shown in FIG. 16, an embodiment of the method (1300) includes (block 1310) directly mixing the ammonium perrhenate with the diamond particles to form a mixture and (block 1320) converting the ammonium perrhenate to a rhenium coating on the diamond particles while heating the mixture at a temperature of at least 350° C. (e.g., heating in a furnace heated to a temperature of at least 350° C.), for example a temperature in a range of about 350° C. to about 750° C., such as a temperature less than about 750° C. As shown in FIG. 17, an embodiment of the method (1400) can also include (block 1402) grinding the ammonium perrhenate to have a particle size in a range of about 0.5 μm to about 1000 μm, (block 1410) directly mixing the ammonium perrhenate with the diamond particles, and (block 1420) converting the ammonium perrhenate to a rhenium coating on the diamond particles. The remaining aspects of the method are substantially the same as those described above with respect to forming rhenium coated metal particles and, therefore, further description thereof will be omitted.

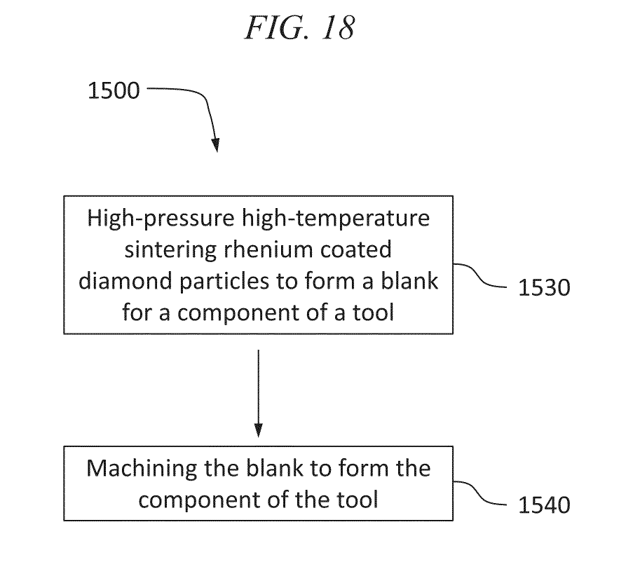

Embodiments of the above-described rhenium coated diamond particles can be used in the manufacture of various tools, such as friction stir welding tools, but the present application is not limited thereto. For example, FIG. 18 is a flowchart illustrating an embodiment of a method (1500) of manufacturing a component of a tool. As shown in FIG. 18, the method (1500) can include (block 1530) high-pressure high-temperature sintering rhenium coated diamond particles to form a blank for a component of a tool. The rhenium coated diamond particles can be formed according to the above-described embodiments. The method (1500) can further include (block 1540) machining the blank to form the component of the tool. The method can also further include mixing the rhenium coated diamond particles with tungsten metal particles before the high-pressure high-temperature sintering. In some embodiments, the method includes mixing the rhenium coated diamond particles with a mixture of tungsten metal particles and rhenium metal particles, and/or the above-described rhenium coated metal particles, before the high-pressure high-temperature sintering. The remaining aspects of the method are substantially the same as those described above with respect to manufacturing a tool using rhenium coated metal particles and, therefore, further description thereof will be omitted. Any suitable tool (e.g., friction stir welding tool) can be made according to embodiments of the subject matter disclosed herein.

### Preparation Example 1

Hydrogen reduction of ammonium perrhenate (NH₄ReO₄) was analyzed to evaluate the feasibility of producing rhenium coated particles according to the methods disclosed herein. The testing was performed by Netzsch Instrument North America, LLC (Burlington, Mass.), a thermal analysis equipment manufacturer and testing company. For example, the sample were analyzed using thermogravimetric (“TG”) analysis, differential scanning calorimetry (“DSC”), and differential thermogravimetric analysis (“DTG”).

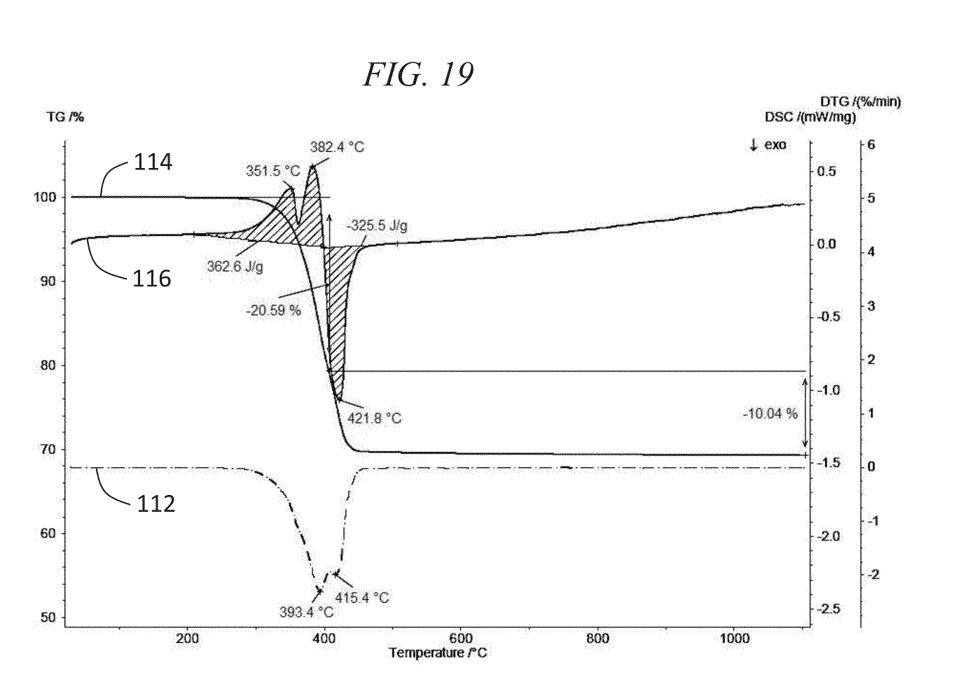

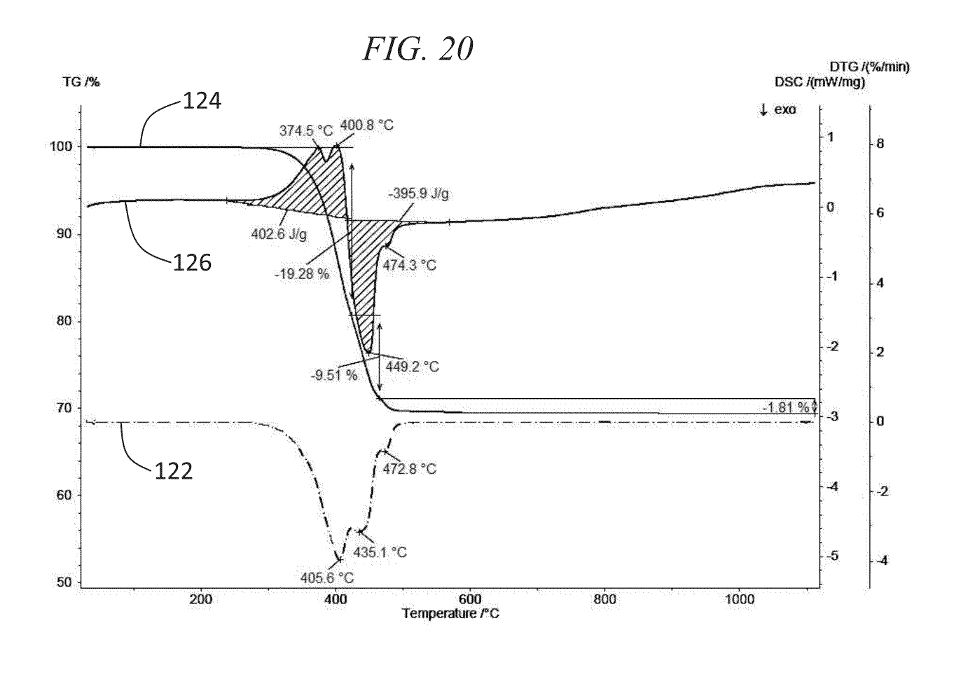

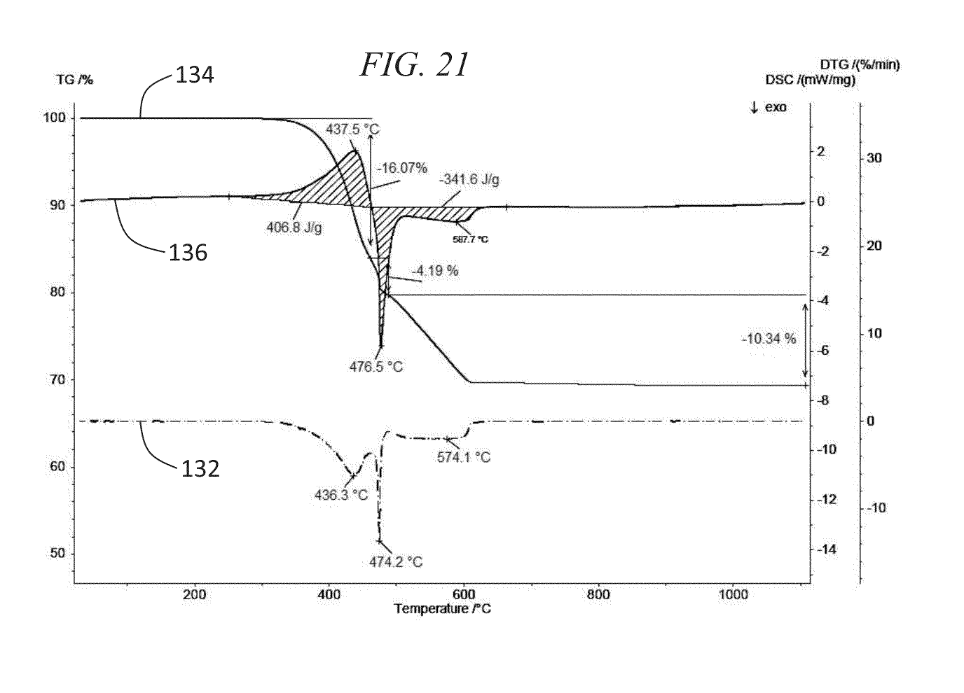

As part of the testing, simultaneous thermal analyses were performed at three heating rates (i.e., 5° C./min, 10° C./min, and 20° C./min) from room temperature to 1100° C. in forming gas (5% hydrogen balancing Ar). The resulting data is shown in FIGS. 19-21 for heating at rates of 5° C./min, 10° C./min, and 20° C./min, respectively (TG shown by the solid lines 114, 124 and 134 in FIGS. 19, 20 and 21, respectively; DTG shown by the dashed lines 112, 122, and 132 in FIGS. 19, 20 and 21, respectively; and DSC shown by the solid lines 116, 126 and 136 in FIGS. 19, 20 and 21, respectively). Analysis of the data indicated that a faster heating rate (e.g., 20° C./min) resulted in a higher peak reaction temperature. Depending on the heating rate, the reduction reaction of the ammonium perrhenate starts at a temperature of about 200° C. and ends at a temperature of less than about 700° C. The total loss of mass from the ammonium perrhenate after reduction at a heating rate of 5° C./min, 10° C./min, and 20° C./min was 30.63%, 30.60%, and 30.60%, respectively. At all three heating rates, the total loss of mass from the ammonium perrhenate is in agreement with the theoretical value corresponding to the complete reduction of ammonium perrhenate to rhenium metal as illustrated by Reaction 1:

2NH₄ReO₄+7H₂→2Re+2NH₃+8H₂O (1)

As can be seen in FIGS. 19-21, each DSC curve shows an endothermic peak followed by an exothermic peak for the three heating rates. In general, reduction reactions are endothermic; thermal decomposition and oxidation reactions are exothermic. However, endothermic peaks observed from DSC analysis may not simply be taken as reactions corresponding to reduction; similarly, exothermic peaks observed from DSC analysis may not simply be thermal decomposition reactions. In a complex reaction system like the reduction of ammonium perrhenate, the endothermic regions are an indication of a reduction dominated reaction zone and, likewise, the exothermic regions suggest a thermal decomposition dominated reaction zone. Therefore, as can be seen in FIGS. 19-21, the ammonium perrhenate can be reduced at a relatively low temperature. While the rising temperature may cause rapid thermal decomposition, it appears that all (or substantially all) reaction products are ultimately reduced to rhenium metal in the end. As described above, the peak reaction temperature increases with faster heating rates in all three instances. The above thermal analysis can be used to establish the onset and end temperatures of the rhenium reduction reaction during the manufacturing process. This information, together with the reaction kinetics exacted therein, can serve as guidelines for designing temperature programs (e.g., furnace heating programs) and quality control.

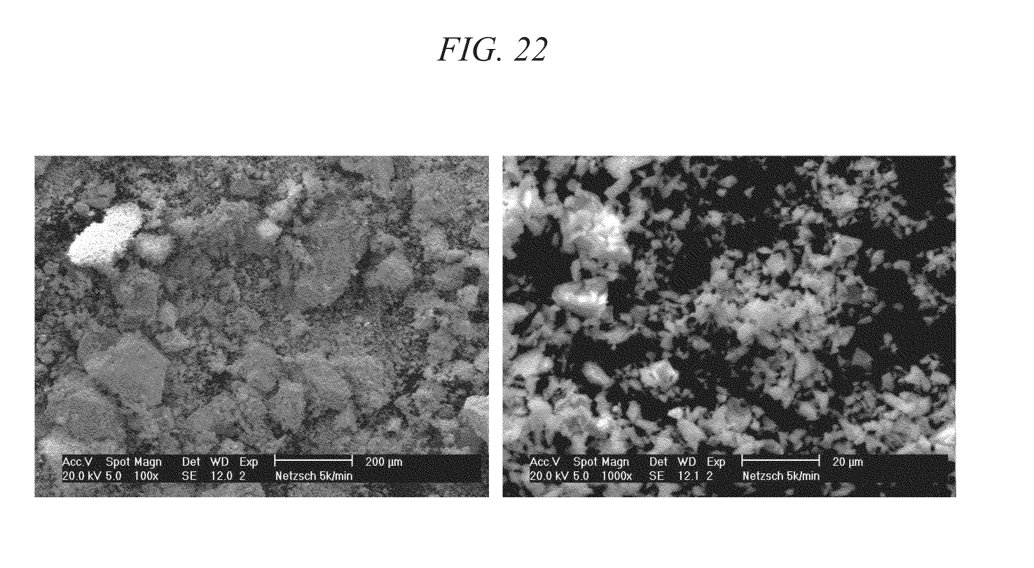

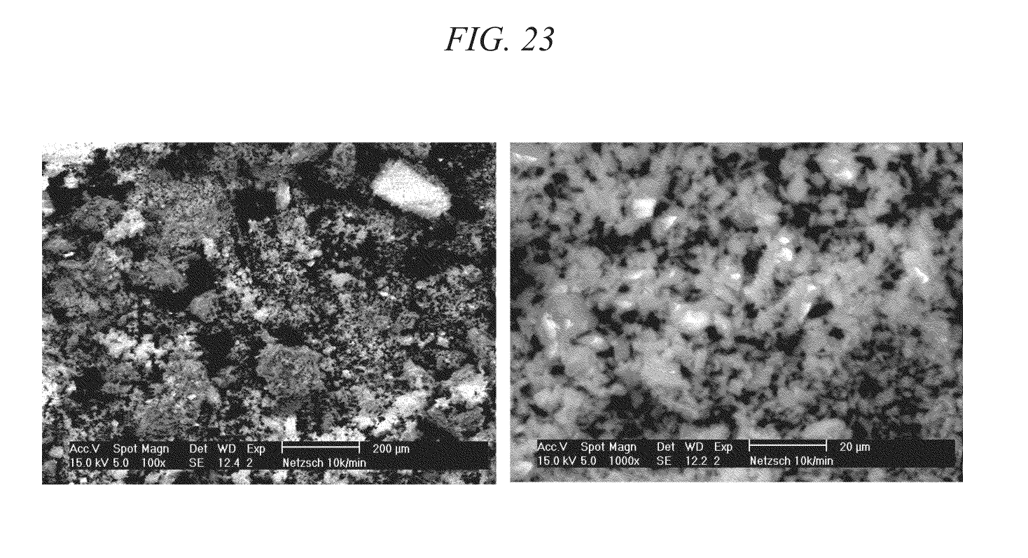

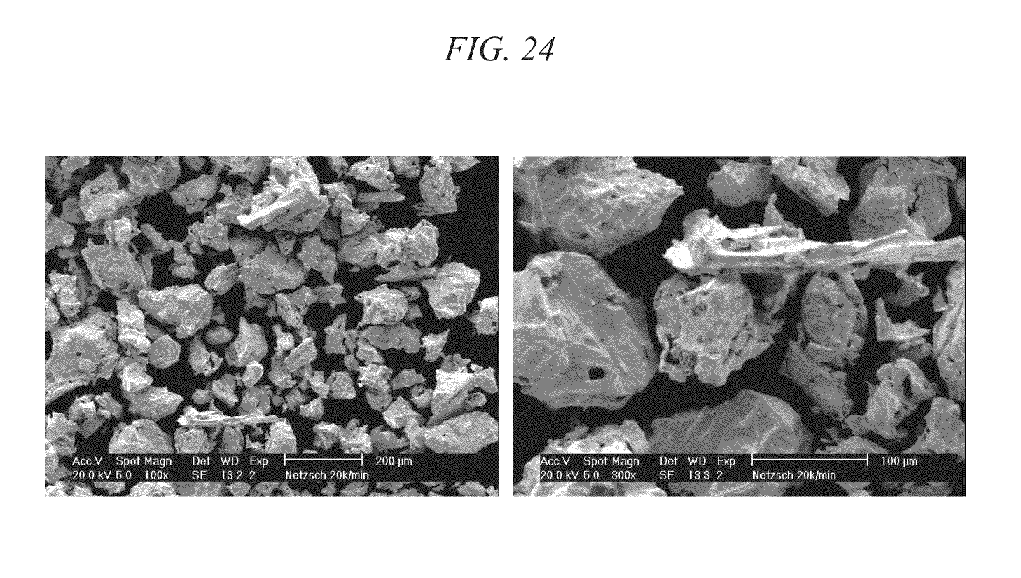

After the testing, the three samples were retrieved from the crucibles and sent to MegaDiamond (Provo, Utah) for further analysis. It was determined from scanning electron microscopy (“SEM”) and composition analysis of the samples that rhenium particles of various sizes were formed. SEM photographs of the rhenium powder produced using the 5° C./min heating rate, the 10° C./min heating rate, and the 20° C./min heating rate are shown in FIGS. 22, 23 and 24, respectively. The rhenium powders produced using the 5 and 10° C./min heating rates appear to be fine agglomerated powders. Most of the particles in those powders have particle sizes less than about 10 μm, and some of the particles have particle sizes that are substantially smaller. The rhenium powder produced using the 20° C./min heating rate has particles having much larger particle sizes, as compared to the particles prepared using the other heating rates. Most of the particles in that powder have a particle size in a range of about 100 μm to about 200 μm. Careful examination of those particles reveals a small granulated texture, which suggests that the larger particles may be the product of recrystallization of the smaller particles over the course of the heating. For each of the three heating rates tested, the reduction of the ammonium perrhenate was completed before the temperature reached 700° C. As the above-described testing achieved a heating temperature of 1100° C., it is possible that recrystallization occurred after the reduction reaction of the ammonium perrhenate was complete.

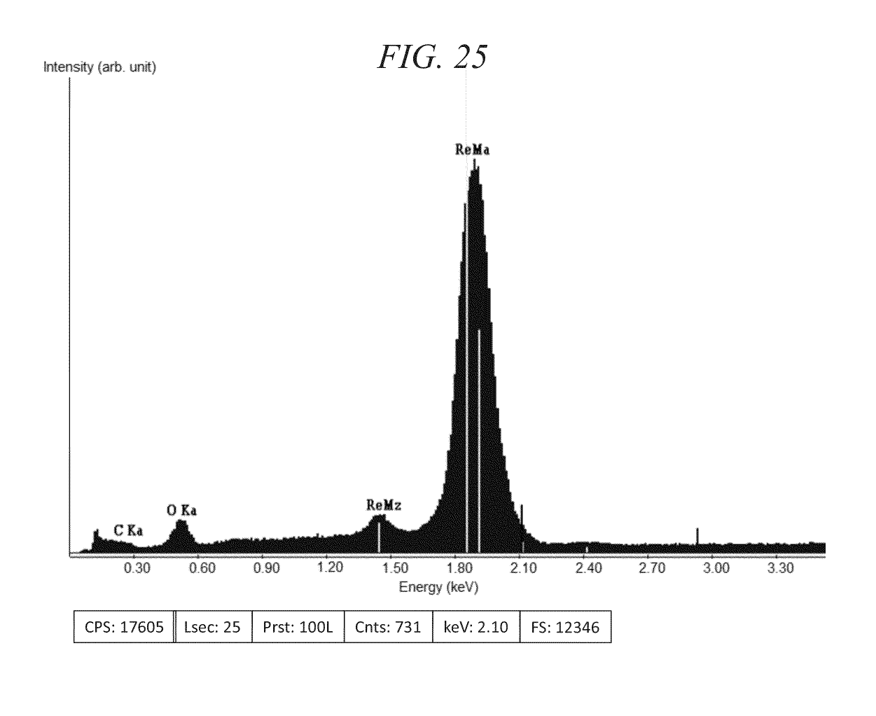

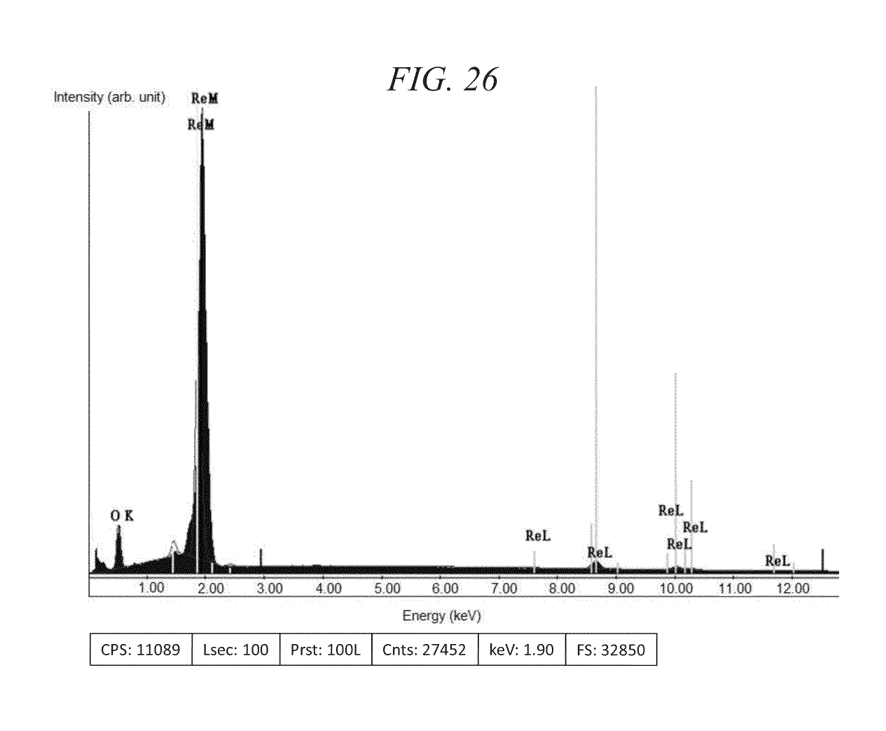

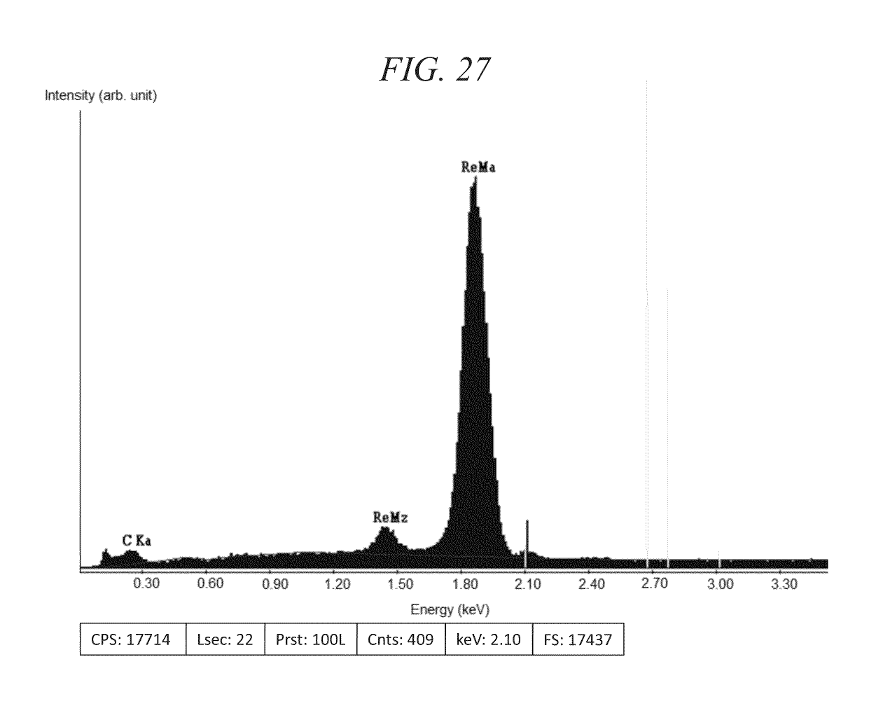

The samples were also analyzed using energy-dispersive X-ray spectroscopy (“EDAX”). The results of the EDAX scans of the rhenium powder produced using the 5° C./min heating rate, the 10° C./min heating rate, and the 20° C./min heating rate are shown in FIGS. 25, 26 and 27, respectively. The degree of oxidation of the samples can be determined from the respective heights of the oxygen peaks shown in FIGS. 25-27. Analysis of the EDAX scans of the samples indicated that there was some oxidation on the smaller particles formed at slower heating rates (e.g., 5° C./min and 10° C./min), suggesting that kinetics play a role in forming a stable rhenium metal powder. In addition to the difference in particle size, the composition of each of the resulting powders also varies. It can be seen from FIGS. 25-27 that oxidation of rhenium particles occurred for reductions performed at slower heating rates (e.g., 5° C./min and 10° C./min). The EDAX spectra also show the presence of oxygen in the powder produced at the slower heating rates. Oxygen is not detected (or is minimally detected) in the sample reduced at the 20° C./min heating rate, indicating a reduction reaction of the ammonium perrhenate has taken place. The above-described differences in particle size may have contributed to the degree of rhenium oxidation since smaller particles are more easily oxidized as a result of their higher surface area to volume ratio, as compared to larger particles. The oxidation of the rhenium most likely occurred when the end product was removed from the crucible and exposed to air after the reduction reaction. To improve the purity and consistency of a metal-rhenium powder (e.g., a tungsten-rhenium powder) care should be taken to avoid such oxidation reactions.

### Example 1

Rhenium coated tungsten metal particles were prepared as follows. Ammonium perrhenate was ground into a fine powder using a set of alumina mortar and pestle. Based on theoretical calculations, tungsten metal powder and ammonium perrhenate were mixed at a ratio such that the atomic percentage of rhenium metal in the final tungsten rhenium powder would be about 25 at. %. In particular, to produce about 500 grams of W—Re powder, about 373.80 grams of tungsten metal powder and about 181.78 grams of ammonium perrhenate were mixed. The powder mixture was placed in an alumina crucible, which was placed in a stainless steel tray. A 400-mesh screen was placed over the stainless steel tray, and the stainless steel tray was placed in a Centorr 1 furnace, available from Centorr Vacuum Industries (Nashua, N.H.).

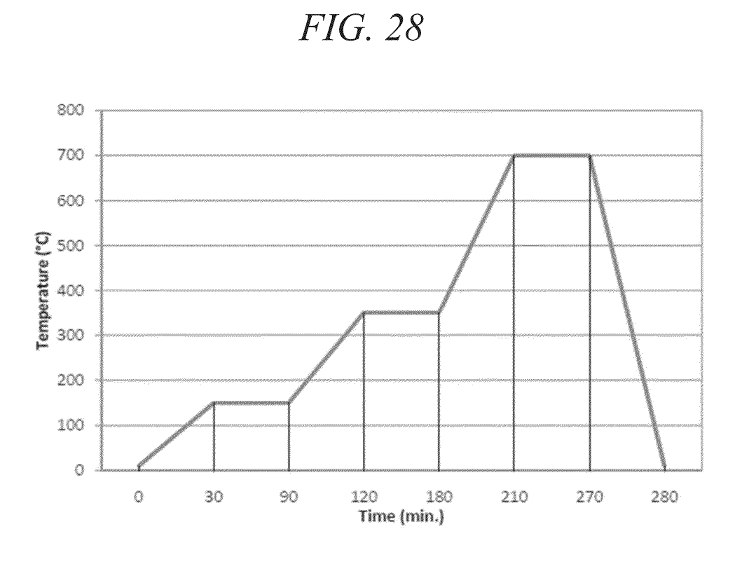

The Centorr 1 was programmed according to the temperature profile shown in FIG. 28. For example, as shown in FIG. 28, the program included a dwell at 150° C. for switching gases from Ar to H₂. The program also included a sixty-minute dwell at 350° C. The furnace temperature was then ramped to 700° C., followed by a sixty-minute isothermal period. The powder product was cooled extensively to a furnace temperature of less than about 30° C. before it was removed from the furnace. The above-described temperature program provided thermal decomposition and reduction of the ammonium perrhenate, and recrystallization and growth of tungsten-rhenium particles, but the subject matter disclosed herein is not limited thereto.

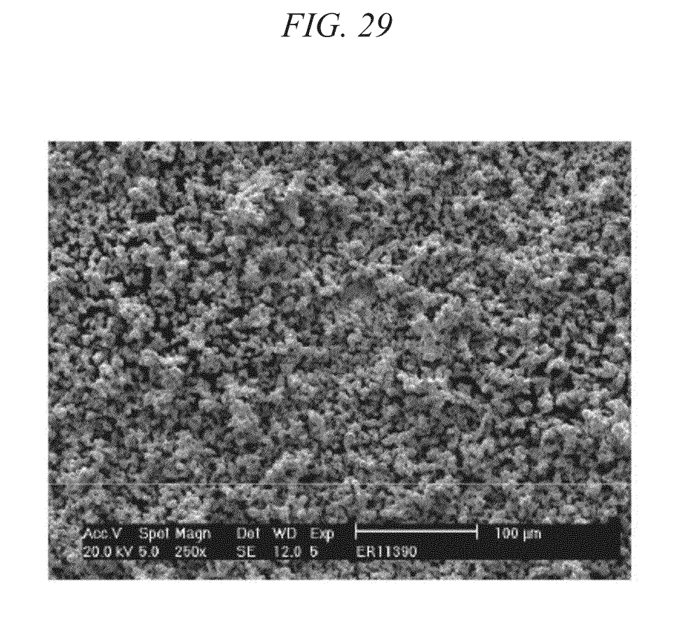

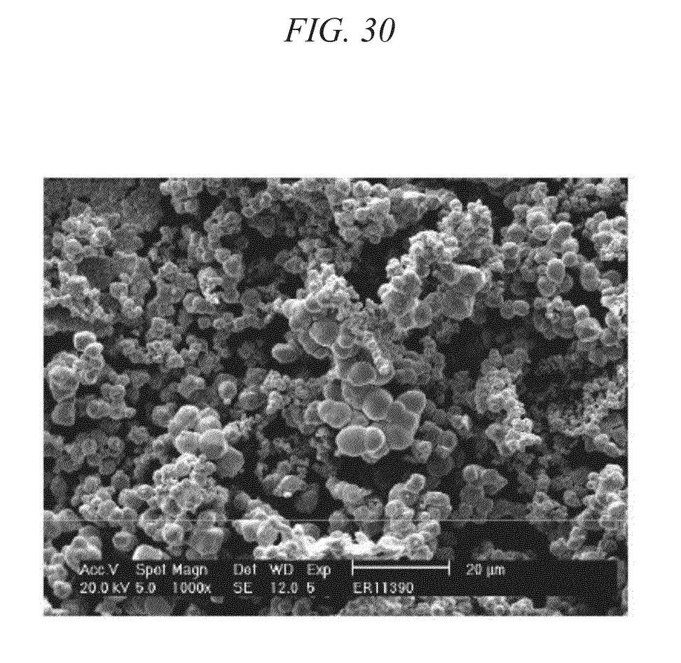

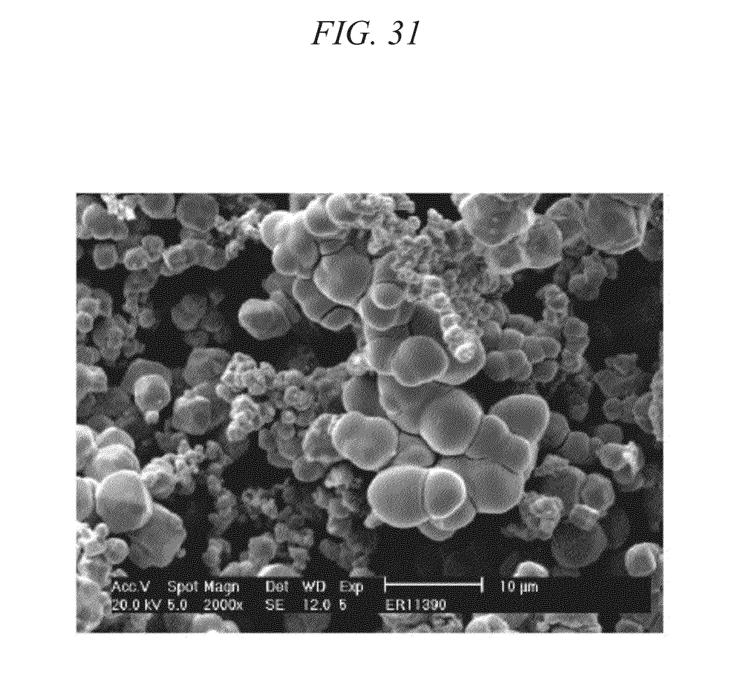

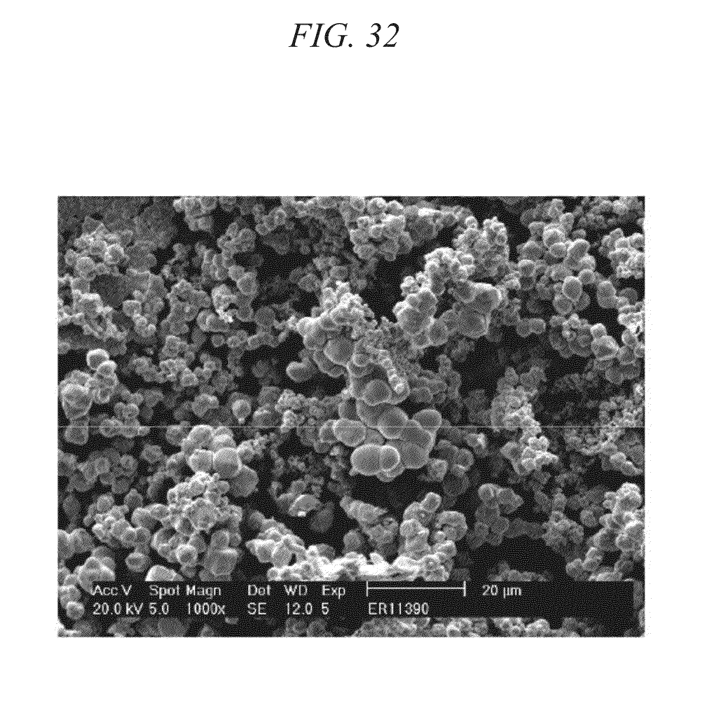

As can be seen in the SEM photographs shown in FIGS. 29-32, the tungsten-rhenium prepared according to the above-described embodiment was uniform and did not have agglomerates of rhenium/rhenium-coated tungsten. This result may be, in part, due to the homogeneous mixing of the ammonium perrhenate and the tungsten metal particles prior to the heating. In contrast, commercially available tungsten-rhenium powders prepared by using a plasma heat source to sputter rhenium on the tungsten surface may be less uniform and may include agglomerated particles. The uniformity of the tungsten-rhenium powder prepared according embodiments of the presently disclosed subject matter may facilitate the uniform dispersion of an ultra-hard material (e.g., cubic boron nitride) in a tungsten-rhenium matrix formed from the tungsten-rhenium powder, and it may improve the uniformity of the microstructure in a sintered material produced from the same.

Although only a few example embodiments have been described in detail above, those skilled in the art will readily appreciate that many modifications are possible in the example embodiments without materially departing from the subject matter of this disclosure. Accordingly, all such modifications are intended to be included within the scope of this disclosure as defined in the following claims. Throughout the text and claims, use of the word “about” reflects the penumbra of variation associated with measurement, significant figures, and interchangeability, all as understood by a person having ordinary skill in the art to which this disclosure pertains. Additionally, throughout this disclosure and the accompanying claims, it is understood that even those ranges that may not use the term “about” to describe the high and low values are also implicitly modified by that term, unless otherwise specified.

What is claimed is:

1. A method of forming rhenium coated metal particles, the method comprising:
directly mixing ammonium perrhenate with metal particles; and
converting the ammonium perrhenate to a rhenium coating on the metal particles.

2. The method of claim 1, wherein the metal particles are tungsten metal particles.

3. The method of claim 1, wherein the converting the ammonium perrhenate comprises reducing the ammonium perrhenate in a reducing atmosphere.

4. The method of claim 3, wherein the directly mixing the ammonium perrhenate with the metal particles forms a mixture and the converting the ammonium perrhenate further comprises heating the mixture at a temperature of at least 350° C.

5. The method of claim 4, further comprising grinding the ammonium perrhenate to have a particle size in a range of about 0.5 μm to about 1000 μm before directly mixing the ammonium perrhenate with the metal particles.

6. A method of manufacturing a component of a tool, the method comprising:
forming rhenium coated metal particles according to the method of claim 1;
mixing the rhenium coated metal particles with an ultra-hard material to form a powder mixture;
high-pressure high-temperature sintering the powder mixture to form a blank for a component of a tool; and
machining the blank to form the component of the tool.

7. A method of forming rhenium coated cubic boron nitride (cBN) particles, the method comprising:
mixing ammonium perrhenate with cBN particles; and
converting the ammonium perrhenate to a rhenium coating on the cBN particles.

8. The method of claim 7, wherein the converting the ammonium perrhenate comprises reducing the ammonium perrhenate in a reducing atmosphere.

9. The method of claim 8, wherein the mixing the ammonium perrhenate with the cBN particles forms a mixture and the converting the ammonium perrhenate further comprises heating the mixture at a temperature of at least 350° C.

10. The method of claim 7, further comprising grinding the ammonium perrhenate to have a particle size in a range of about 0.5 μm to about 1000 μm before mixing the ammonium perrhenate with the cBN particles.

11. A method of manufacturing a component of a tool, the method comprising:
forming rhenium coated cBN particles according to the method of claim 7;
high-pressure high-temperature sintering the cBN particles to form a blank for a component of a tool; and
machining the blank to form the component of the tool.

12. The method of claim 11, further comprising mixing the rhenium coated cBN particles with tungsten metal particles before the high-pressure high-temperature sintering.

13. The method of claim 11, further comprising mixing the rhenium coated cBN particles with a mixture of tungsten metal particles and rhenium metal particles before the high-pressure high-temperature sintering.

14. A method of forming rhenium coated diamond particles, the method comprising:
mixing ammonium perrhenate with diamond particles; and
converting the ammonium perrhenate to a rhenium coating on the diamond particles.

15. The method of claim 14, wherein the converting the ammonium perrhenate comprises reducing the ammonium perrhenate in a reducing atmosphere.

16. The method of claim 15, wherein the mixing the ammonium perrhenate with the diamond particles forms a mixture and the converting the ammonium perrhenate further comprises heating the mixture at a temperature of at least 350° C.

17. The method of claim 14, further comprising grinding the ammonium perrhenate to have a particle size in a range of about 0.5 μm to about 1000 μm before mixing the ammonium perrhenate with the diamond particles.

18. A method of manufacturing a component of a tool, the method comprising:
forming rhenium coated diamond particles according to the method of claim 14;
high-pressure high-temperature sintering the rhenium coated diamond particles to form a blank for a component of a tool; and
machining the blank to form the component of the tool.

19. The method of claim 18, further comprising mixing the rhenium coated diamond particles with tungsten metal particles before the high-pressure high-temperature sintering.

20. The method of claim 18, further comprising mixing the rhenium coated cBN particles with a mixture of tungsten metal particles and rhenium metal particles before the high-pressure high-temperature sintering.
